(19) United States
(12) Patent Application Publication
(10) Pub. No.: US 2012/0086627 A1
(43) Pub. Date: Apr. 12, 2012

(54) Display Device with Bi-directional Shift Registers

(76) Inventors: Yung-Chih Chen, Hsin-Chu (TW); Kuo-Hua Hsu, Hsin-Chu (TW); Kun-Yueh Lin, Hsin-Chu (TW); Yu-Chung Yang, Hsin-Chu (TW); Yu-Hsi Ho, Hsin-Chu (TW)

(21) Appl. No.: 13/270,233

(22) Filed: Oct. 11, 2011

(30) Foreign Application Priority Data
Oct. 12, 2010 (TW) 099134704

(51) Int. Cl. G09G 3/36

(52) U.S. Cl. 345/100

(57) ABSTRACT

A display device having bi-directional shift registers is disclosed. The display device includes a display panel which has N gate lines, a first set of dummy registers, a second set of dummy registers, a plurality of valid shift registers coupled between the two sets of dummy registers, and a first start pulse signal generator coupled to the first valid register for generating the first start pulse signal to the first valid register to enable the first gate line. The first valid register is coupled to the first set of dummy registers. The Nth valid register is coupled to the second set of dummy registers.

### BACKGROUND OF THE INVENTION

1. Technical Field

The present invention relates to a display having bi-directional shift registers, and more particularly to a display in which a start pulse signal is inputted directly to a non-first-stage dummy shift register.

2. Description of the Prior Art

FIG. 1 is a diagram of a liquid crystal display 100. The liquid crystal display 100 comprises a display area 102, a plurality of gate lines 104, a plurality of valid shift registers 106, and a plurality of dummy shift registers 108. The valid shift registers 106 are shift registers whose output is directly coupled to the display area 102. As shown in FIG. 1, for a traditional display design, due to the plurality of dummy shift registers 108 required to be added at a transmission end, bi-directional effective shift registers are bracketed by the plurality of dummy shift registers. However, when a downward start pulse signal 110 or an upward start pulse signal 112 is pulsed, a first stage effective scan line generates a delay due to the dummy shift register, such that data output requires additional memory for storage, increasing complexity and cost of manufacturing.

Please refer to FIG. 2A, FIG. 2B, and FIG. 2C. FIG. 2A is a circuit block diagram of the valid shift register and the dummy shift register of FIG. 1. FIG. 2B is a timing diagram of driving all gate lines 104 according to a top-to-bottom driving order. FIG. 2C is a timing diagram of driving all gate lines 104 according to a bottom-to-top driving order. After a downward start pulse signal generator 200 generates a downward start pulse signal (ST_D) 202 as an output signal inputted to the first stage dummy shift register 210 for triggering the dummy shift register 210, the dummy shift register 210 transmits a downward pulse signal (Dummy_U1) 204 as an output signal to the second stage dummy shift register 212 in time with the first clock signal (CK1). After the downward pulse signal 204 is sent to the second stage dummy shift register 212 to trigger the second stage dummy shift register 212, the second stage dummy shift register 212 transmits a downward pulse signal (Dummy_U2) 206 as an output signal to the first stage valid shift register 214 in time with a second clock signal (CK2). After the output signal transmits the downward pulse signal 206 to the first stage valid shift register 214 for triggering the first stage valid shift register 214, the first stage valid shift register 214 transmits a downward pulse signal (ST_1) 208 to the second stage valid shift register 216 as an output signal in time with the first clock signal (CK1). This process continues until the final stage dummy register outputs its downward pulse signal. Conversely, after an upward start pulse signal generator 201 inputs an upward start pulse signal (ST_U) 222 as an output signal to the final stage dummy shift register 230 for triggering the final stage dummy shift register 230, the final stage dummy shift register 230 transmits an upward pulse signal (Dummy_D2) 224 as an output signal in time with the second clock signal (CK2) to the second to final stage dummy shift register 232. After the output signal transmits the upward pulse signal 224 to the second to last stage dummy shift register 232 for triggering the second to last stage shift register 232, the second to last stage dummy shift register 232 transmits an upward pulse signal (Dummy_D1) 226 as an output signal in time with the first clock signal (CK1) to the final valid shift register 234. After the output signal transmits the upward pulse signal 226 to the final valid shift register 234 for triggering the final valid shift register 234, the final valid shift register 234 transmits an upward pulse signal (ST_1080) 228 through an output signal line in time with the second clock signal (CK2) to the second to last stage valid shift register 236. This process continues until the first stage dummy register outputs an upward pulse signal.

Please refer to FIG. 2A and FIG. 2B. The downward start pulse signal 202 is inputted to the first stage dummy shift register 210 in pulse form. Thereafter, the first stage dummy shift register 210 outputs the pulse (downward pulse signal 204) to the second stage dummy shift register 212, and the second stage dummy shift register 212 outputs the pulse (downward pulse signal 206) to the first stage valid shift register 214, and the first stage valid shift register 214 outputs the pulse (downward pulse signal 208) to the second stage valid shift register 216. When the downward pulse signal 208 is synchronous with the first clock signal (CK1), first effective data (D1) is read. Thereafter, the output signal line of each effective shift register transmits a pulse acting as the start input signal (ST_2, ST_3, ST_4 . . . ) of the next effective shift register in sequence, and effective data (D2, D3, D4 . . . ) is read out according to the transmission method described above until the output signal line of the final dummy shift register 230 transmits the final pulse (Dummy_D2). The start pulse transmission shift is described above for a downward shift, where each shift register completes data transmission in the same direction. Please refer to FIG. 2A and FIG. 2C. The upward start pulse signal 222 is inputted to the final dummy shift register 230 as a pulse. Thereafter, the final dummy shift register 230 outputs the pulse (upward pulse signal 224) to the second to last stage dummy shift register 232, the second to last stage dummy shift register 232 outputs the pulse (upward pulse signal 226) to the final valid shift register 234, and the final valid shift register 234 outputs the pulse (upward pulse signal 228) to the second to last stage valid shift register 236. When the upward pulse signal 228 is synchronous with the second clock signal (CK2), the first effective data (D1) is read. Then, the output signal line of each effective shift register transmits a pulse acting as a start input signal (ST_1079, ST_1078, ST_1077 . . . ) to the previous effective shift register in sequence, and effective data (D2, D3, D4 . . . ) is read out according to the transmission method described above until the output signal line of the first stage dummy shift register 210 outputs the final pulse (Dummy_U1). The start pulse shift is described above for an upward shift, where each shift register completes data transmission in the same direction.

The method described above inputs the start pulse signal to the final dummy shift register. If the final dummy shift register is bi-directional, a certain delay must occur in the data signal, which slows down transmission of the pulse signal.

### SUMMARY

According to an embodiment, a display comprises a display panel having N gate lines, a first group of dummy shift registers comprising at least one dummy shift register, a second group of dummy shift registers comprising at least one dummy shift register, a plurality of valid shift registers coupled between the second group of dummy shift registers, a first valid shift register coupled to the first group of dummy shift registers, an Nth valid shift register coupled to the second group of dummy shift registers, and a first-directional start pulse signal generator coupled to the first valid shift register for inputting a first-directional start pulse signal to the first valid shift register for enabling a first gate line.

According to another embodiment, a display comprises a display panel having N gate lines, and a first group of dummy shift registers having m dummy shift registers. An ith dummy shift register is coupled to an (i+1)th dummy shift register, and m−1≧i≧1. The display further comprises a second group of dummy shift registers, a plurality of valid shift registers coupled between the second group of dummy shift registers, a first valid shift register coupled to an mth dummy shift register of the first group of dummy shift registers, an Nth valid shift register coupled to the second group of dummy shift registers, and a first-directional start pulse signal generator coupled to a jth dummy shift register of the first group of dummy shift registers for inputting a first-directional start pulse signal to the jth dummy shift register, where j does not equal 1.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a liquid crystal display.

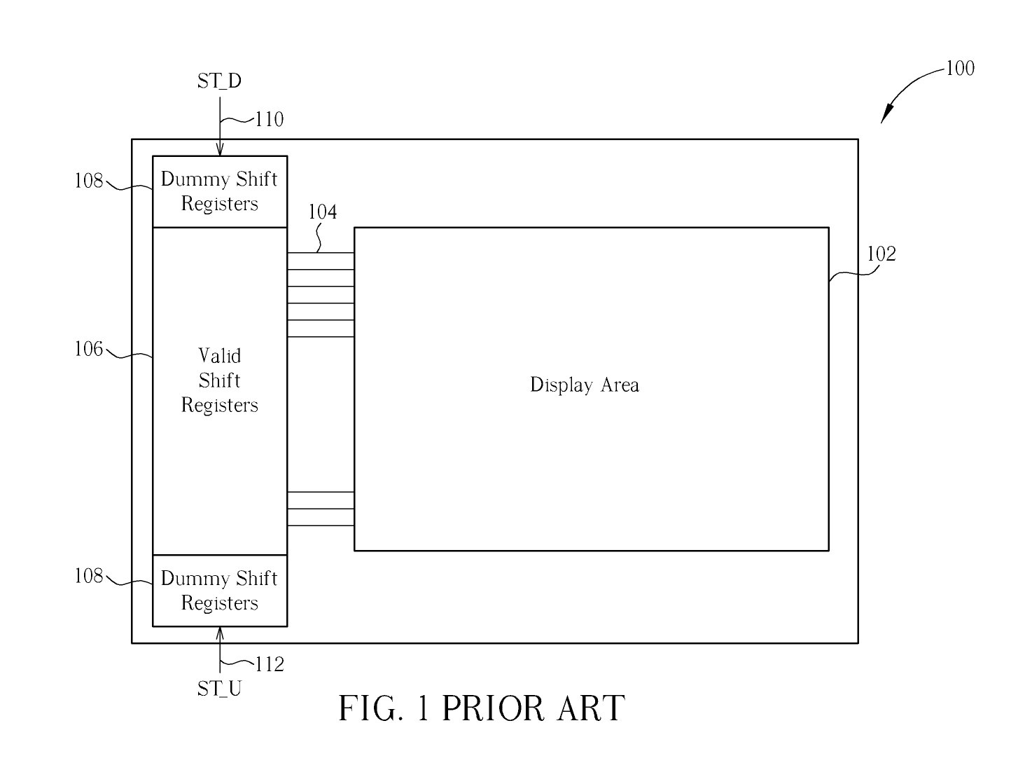

FIG. 2A is a circuit block diagram of the valid shift register and the dummy shift register of FIG. 1.

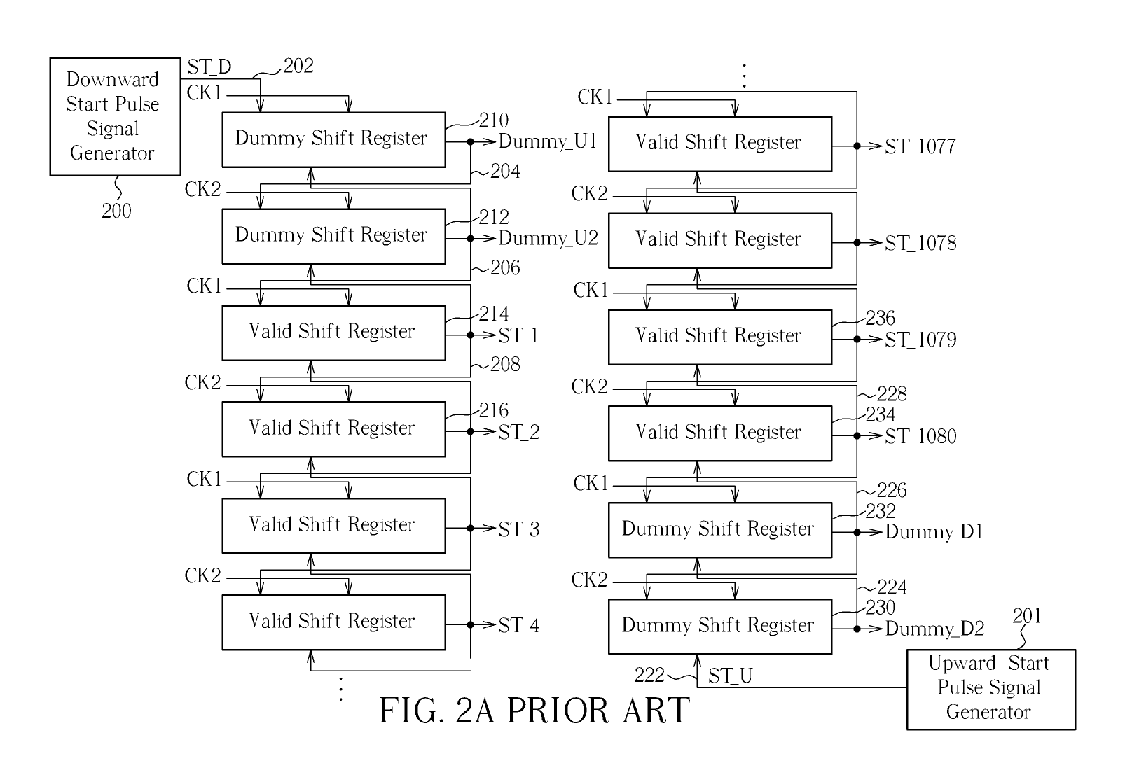

FIG. 2B is a timing diagram of driving all gate lines according to a top-to-bottom driving order.

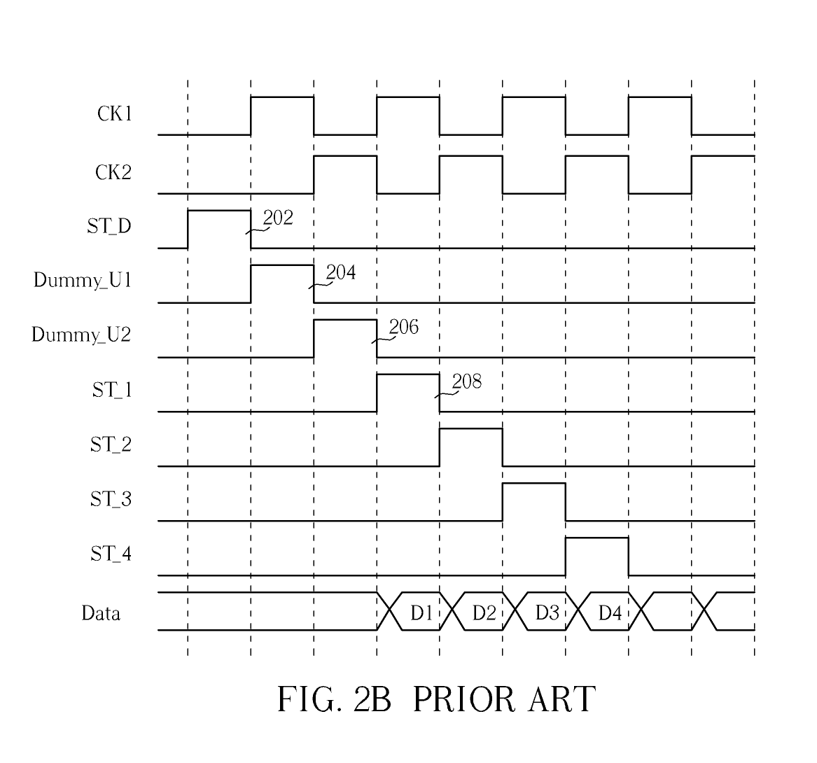

FIG. 2C is a timing diagram of driving all gate lines according to a bottom-to-top driving order.

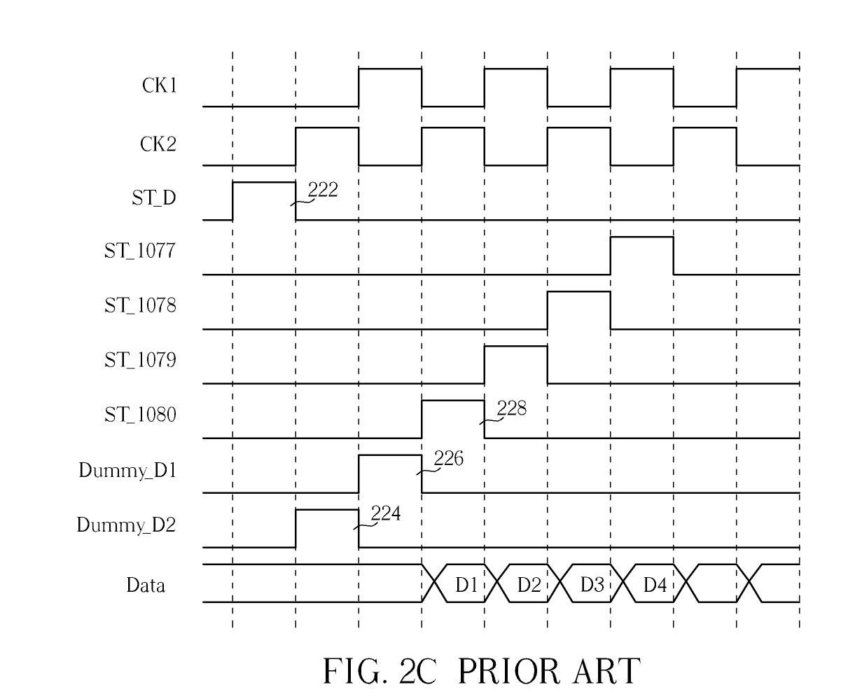

FIG. 3A is a diagram of a display according to an embodiment.

FIG. 3B is a timing diagram of driving all gate lines according to a top-to-bottom driving sequence.

FIG. 3C is a timing diagram of driving all gate lines according to a bottom-to-top driving sequence.

FIG. 4A is a circuit block diagram of a shift register according to a first embodiment.

FIG. 4B is a partial timing diagram showing a top-to-bottom shift according to the first embodiment.

FIG. 4C is a partial timing diagram showing a bottom-to-top shift according to the first embodiment.

FIG. 5A is a circuit block diagram illustrating a shift register according to a second embodiment.

FIG. 5B is a partial timing diagram showing a top-to-bottom shift according to the second embodiment.

FIG. 5C is a partial timing diagram showing a bottom-to-top shift according to the second embodiment.

FIG. 6A is a circuit block diagram illustrating a shift register according to a third embodiment.

FIG. 6B is a partial timing diagram showing a top-to-bottom shift according to the third embodiment.

FIG. 6C is a partial timing diagram showing a bottom-to-top shift according to the third embodiment.

FIG. 7A is a circuit block diagram illustrating a shift register according to a fourth embodiment.

FIG. 7B is a partial timing diagram showing a top-to-bottom shift according to the fourth embodiment.

FIG. 7C is a partial timing diagram showing a bottom-to-top shift according to the fourth embodiment.

FIG. 8A is a circuit block diagram illustrating a shift register according to a fifth embodiment.

FIG. 8B is a partial timing diagram showing a top-to-bottom shift according to the fifth embodiment.

FIG. 8C is a partial timing diagram showing a bottom-to-top shift according to the fifth embodiment.

### DETAILED DESCRIPTION

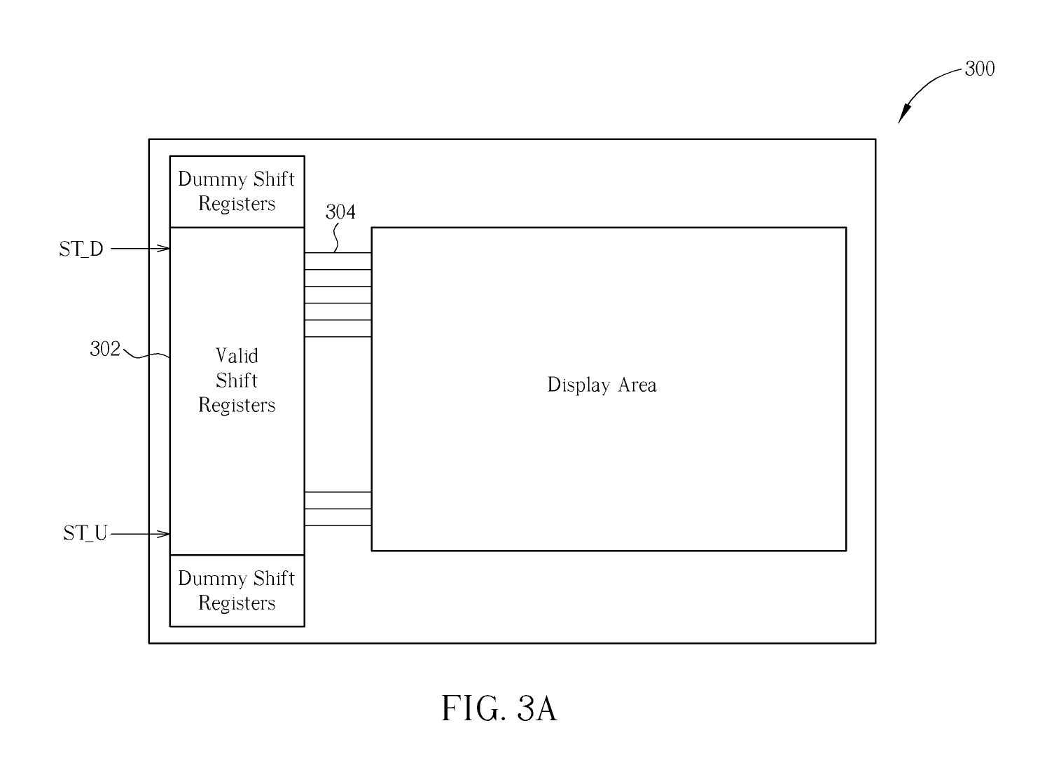

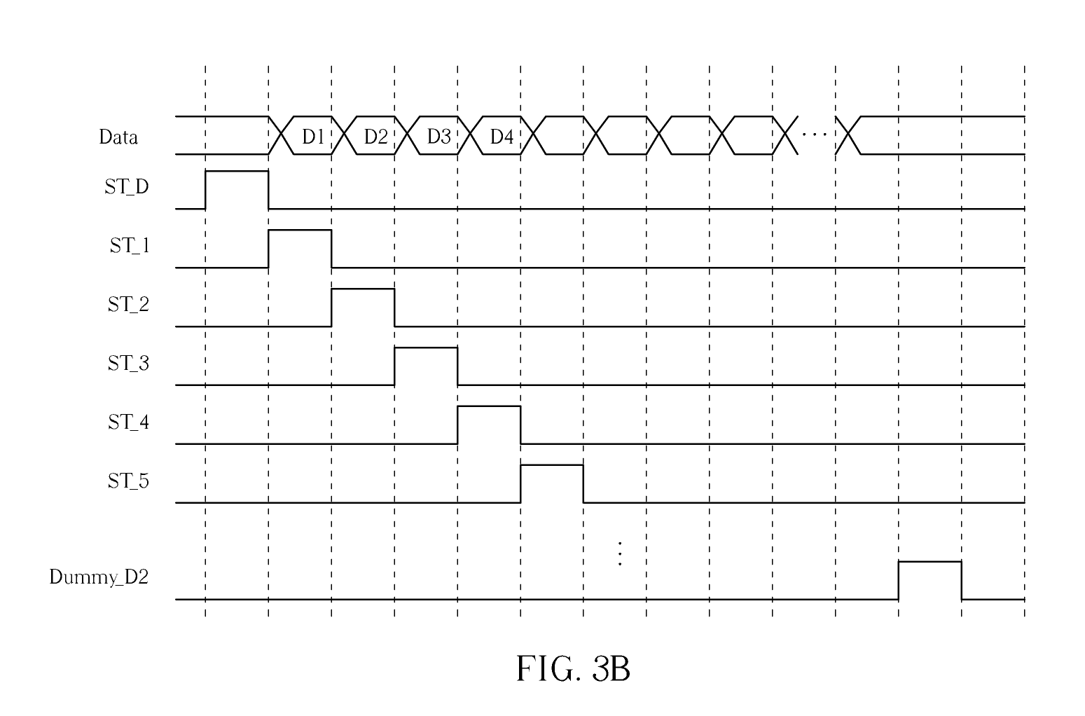

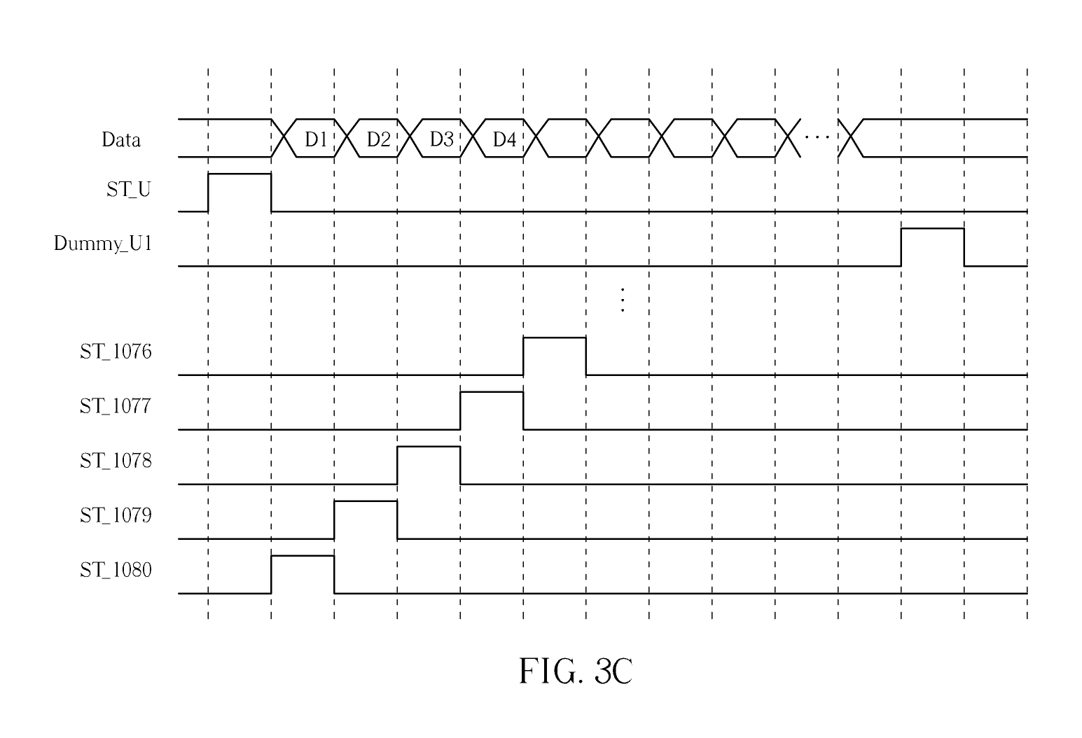

FIG. 3A is a diagram of a display 300 according to an embodiment. The display 300 comprises a display area, a plurality of gate lines 304, a plurality of valid shift registers 302, and two sets of dummy shift registers coupled to a first stage valid shift register and a last stage valid shift register of the plurality of valid shift register 302, respectively. Each set of dummy shift registers comprises at least one dummy shift register. A downward start pulse signal and an upward start pulse signal of the display 300 are directly transmitted to the first stage valid shift register and the last stage valid shift register, respectively, such that this design architecture has bi-directional functionality, and is not required to delay data signals. Timing relationships thereof may be the same as normal unidirectional transmission, as shown in FIG. 3B and FIG. 3C. FIG. 3B is a timing diagram of driving all gate lines 304 according to a top-to-bottom driving sequence. FIG. 3C is a timing diagram of driving all gate lines 304 according to a bottom-to-top driving sequence.

Please refer to FIG. 3A and FIG. 3B. When resolution is set to 1080 gate lines, a downward pulse signal (ST_D) is inputted in pulse form to the first stage valid shift register through an output signal line. The first stage valid shift register outputs a downward trigger signal (ST_1) in pulse form to the second stage valid shift register through an output signal line, and first valid data is read out. Then, after the second stage valid shift register receives the downward trigger signal (ST_1), a downward trigger signal (ST_2) is outputted in pulse form to the third stage valid shift register through an output signal line, and second valid data (D2) is read out. This process is repeated until the last stage dummy shift register outputs a downward trigger signal (Dummy_D2) through an output signal line to complete the downward shift action.

Please refer to FIG. 3A and FIG. 3C. When resolution is set to 1080 gate lines, an upward start pulse signal (ST_U) is inputted in pulse form to the 1080th stage valid shift register through an output signal line. The 1080th stage valid shift register outputs an upward trigger signal (ST_1080) in pulse form to the 1079th stage valid shift register through an output signal line, and first valid data is read out. Then, after the 1079th stage valid shift register receives the upward trigger signal (ST_1080), an upward trigger signal (ST_1079) is outputted in pulse form to the 1078th stage valid shift register through an output signal line, and second valid data (D2) is read out. This process is repeated until the first stage dummy shift register outputs upward trigger signal (Dummy_U1) through an output signal line to complete the upward shift action.

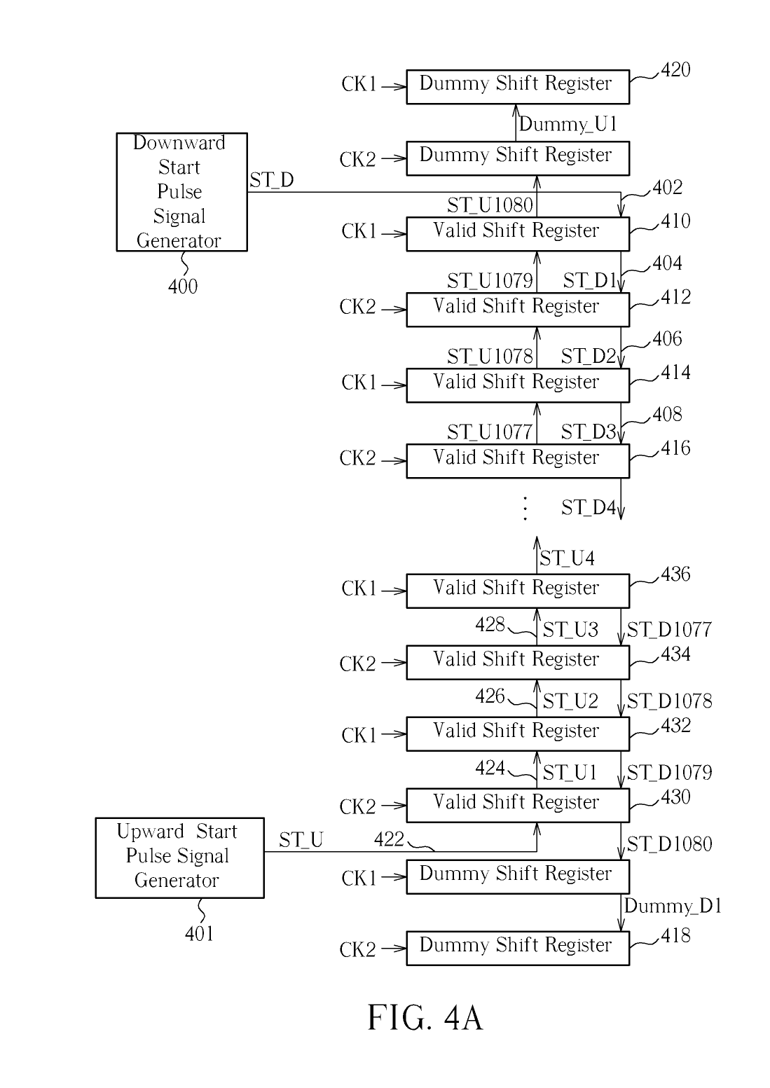

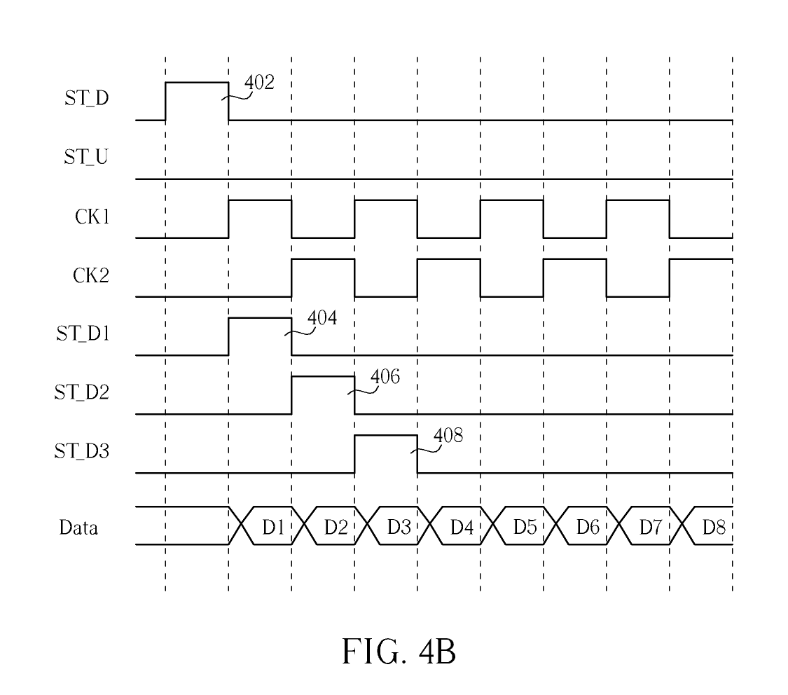

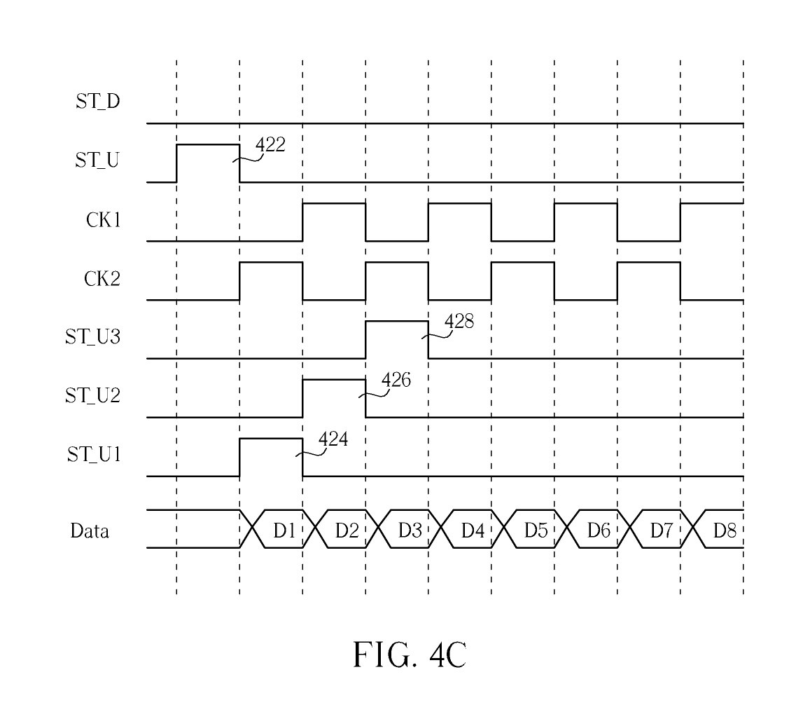

Please refer to FIG. 4A, FIG. 4B, and FIG. 4C. FIG. 4A is a circuit block diagram of a shift register according to a first embodiment. FIG. 4B is a partial timing diagram showing a top-to-bottom shift according to the first embodiment, and FIG. 4C is a partial timing diagram showing a bottom-to-top shift according to the first embodiment. Both groups of dummy shift registers individually comprise two dummy shift registers in this embodiment.

Please refer to FIG. 4A. After downward start pulse signal generator 400 inputs a downward start pulse signal (ST_D) 402 to first stage valid shift register 410 through an output signal line to trigger first stage valid shift register 410, first stage valid shift register 410 sends downward trigger signal (ST_D1) 404 to second stage valid shift register 412 through an output signal line in time with first clock signal (CK1). After downward trigger signal (ST_D1) 404 is sent to second stage valid shift register 412 to trigger second stage valid shift register 412, second stage valid shift register 412 sends downward trigger signal (ST_D2) 406 to third stage valid shift register 414 through an output signal line in time with second clock signal (CK2), After downward trigger signal (ST_D2) 406 is sent to third stage valid shift register 414 to trigger third stage valid shift register 414, third stage valid shift register 414 sends downward trigger signal (ST_D3) 408 to fourth valid shift register 416 through an output signal line in time with first clock signal (CK1). This process is repeated until the last stage dummy shift register 418 receives a downward trigger signal.

After upward start pulse signal generator 401 inputs an upward start pulse signal (ST_U) 422 to the last stage valid shift register 430 through an output signal line to trigger the last stage valid shift register 430, the last stage valid shift register 430 sends upward signal (ST_U1) 424 to the second-to-last stage valid shift valid shift register 432 through an output signal line in time with the second clock signal (CK2). After the upward start pulse signal (ST_U1) 424 is sent to the second-to-last stage valid shift register 432 to trigger the second-to-last stage valid shift register 432, the second-to-last stage valid shift register 432 sends upward trigger signal (ST_U2) 426 to third-to-last stage valid shift register 434 through an output signal line in time with the first clock signal (CK1). After upward trigger signal (ST_U2) 426 is sent to the third-to-last stage valid shift register 434 to trigger the third-to-last stage valid shift register 434, the third-to-last stage valid shift register 434 sends upward trigger signal (ST_U3) 428 to fourth-to-last stage valid shift register 436 through an output signal line in time with the second clock signal (CK2). This process continues until the first stage dummy shift register 420 receives an upward trigger signal.

Please refer to FIG. 4A and FIG. 4B. Downward start pulse signal 402 is inputted to the first stage valid shift register 410 in pulse form. Then, the first stage valid shift register 410 outputs the pulse (downward trigger signal 404) to the second stage valid shift register 412. Also, when downward trigger signal 404 and first clock signal (CK1) move simultaneously, the first valid data (D1) is read. Then, the second stage valid shift register 412 outputs the pulse (downward trigger signal 406) to the third stage valid shift register 414. When the downward trigger signal 406 and the second clock signal (CK2) move together, the second valid data (D2) is read. Then, the third stage valid shift register 414 outputs the pulse (downward trigger signal 408) to the fourth stage valid shift register 416. Also, as the downward trigger signal 408 and the first clock signal (CK1) move together, the third valid data (D3) is read. In the same manner, the output signal line of each shift register stage outputs a pulse (ST_D4, . . . , ST_D1080, Dummy_D1) sequentially to trigger the next-stage shift register, and data (D4, D5, D6 . . . ) is read out gradually according to the transmission process described above until the last stage dummy shift register 418 receives the last stage pulse Dummy_D1. The start pulse shift operation described above is a downward shift, and each shift register stage operates in the same direction while completing data transmission. Please refer to FIG. 4A and FIG. 4C. An upward start pulse signal 422 is inputted in pulse form to the last stage valid shift register 430. Then, the last stage valid shift register 430 outputs the pulse (upward trigger signal 424) to the second-to-last stage valid shift register 432. Also, when the upward trigger signal 424 and the second clock signal (CK2) move simultaneously, the first valid data (D1) is read. Then, the second-to-last stage valid shift register 432 outputs the pulse (upward trigger signal 426) to the third-to-last stage valid shift register 434. When the upward trigger signal 426 and the first clock signal (CK1) move simultaneously, the second valid data (D2) is read. Then, the third-to-last stage valid shift register 434 outputs the pulse (upward trigger signal 428) to the fourth-to-last stage valid shift register 436. Also, when the upward trigger signal 428 and the second clock signal (CK2) move simultaneously, the third valid data (D3) is read out. In the same manner, the output signal line of each shift register stage sends a pulse (ST_U4, . . . , ST_U1080, Dummy_U1) sequentially to trigger the previous-stage shift register, and data (D4, D5, D6 . . . ) is read out gradually according to the transmission process described above until the first stage dummy shift register 420 receives the last pulse Dummy_U1. The start pulse shift operation described above is an upward shift, and each shift register stage operates in the same direction while completing data transmission. In this embodiment, each dummy shift register maybe a unidirectional shift register instead of a bi-directional shift register, because the dummy shift registers shown in FIG. 4A are only used for transferring the trigger signals in one direction.

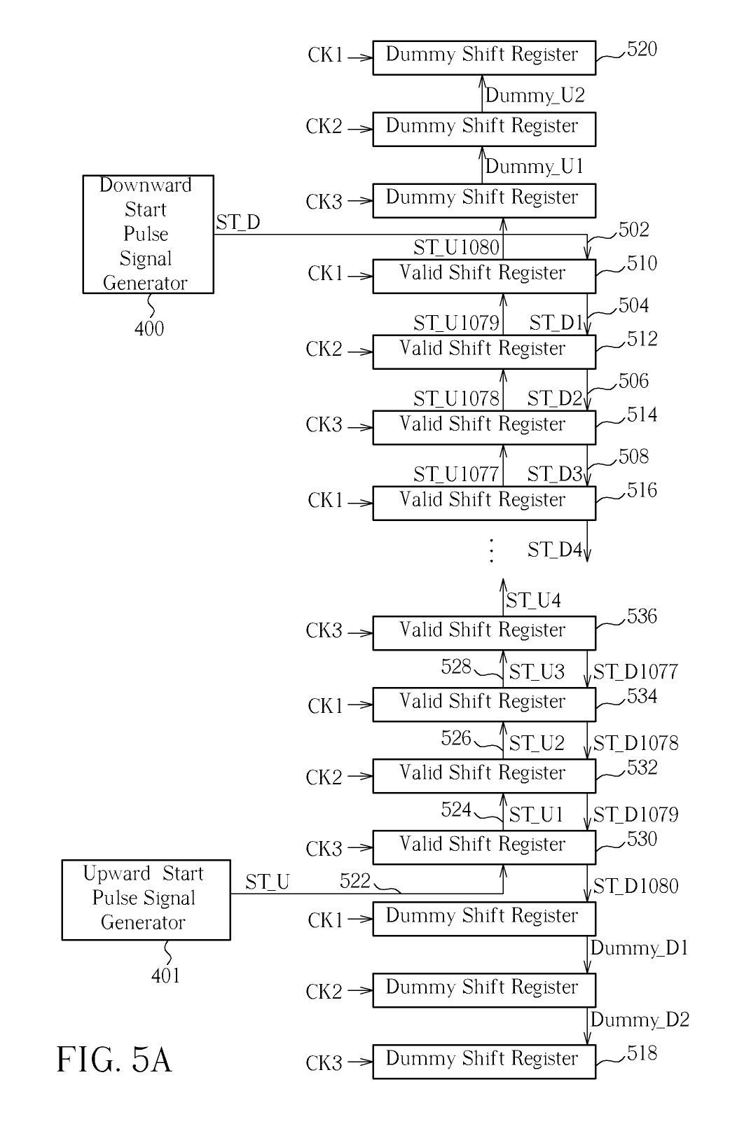

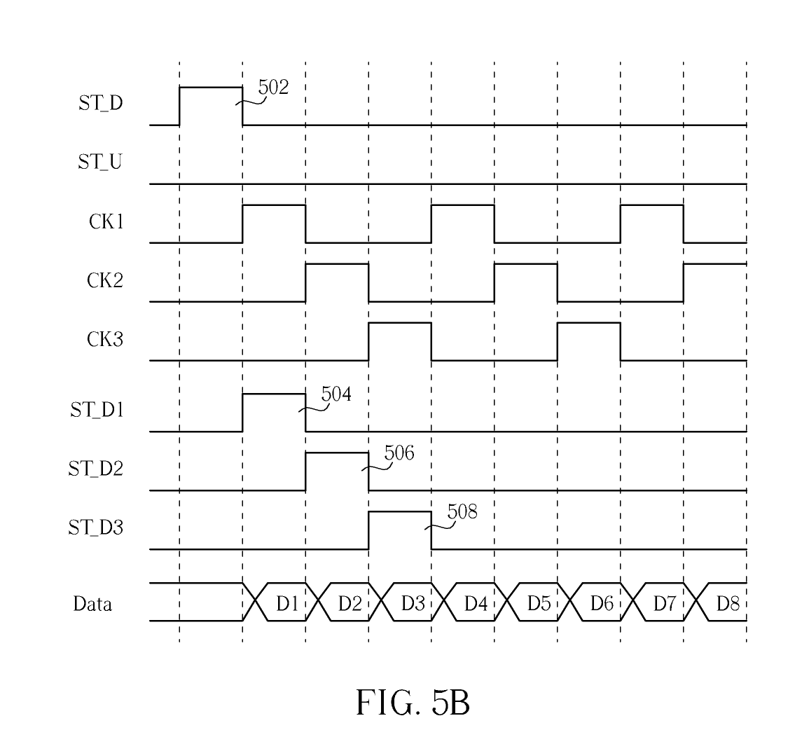

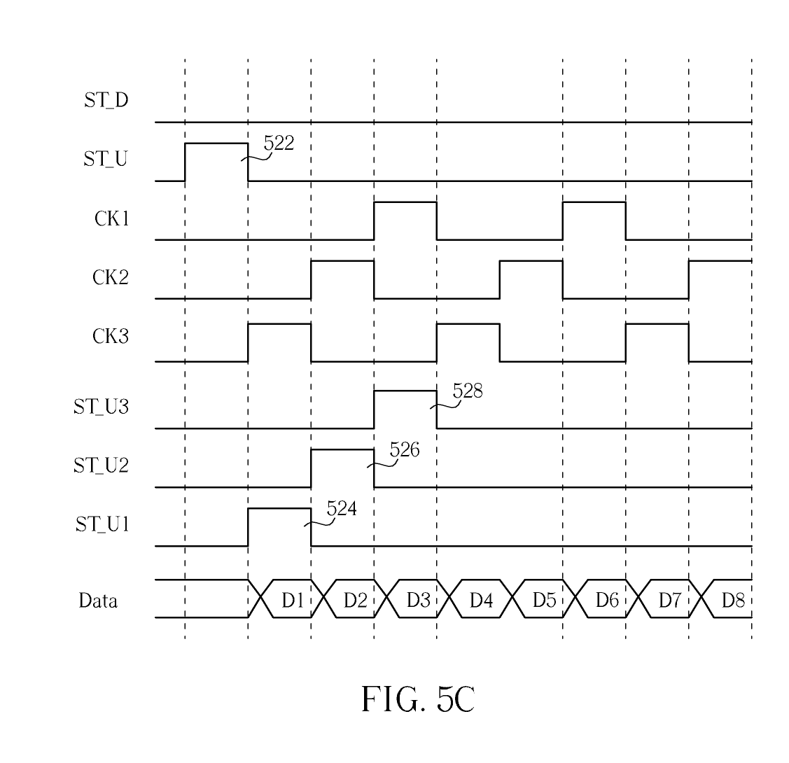

Please refer to FIG. 5A, FIG. 5B, and FIG. 5C. FIG. 5A is a circuit block diagram illustrating a shift register according to a second embodiment. FIG. 5B is a partial timing diagram showing a top-to-bottom shift according to the second embodiment, and FIG. 5C is a partial timing diagram showing a bottom-to-top shift according to the second embodiment. In the present embodiment, two groups of dummy shift registers individually comprise three dummy shift registers. Please refer to FIG. 5A. After downward start pulse signal generator 400 inputs a downward start pulse signal (ST_D) 502 to first stage valid shift register 510 through an output signal line to trigger the first stage valid shift register 510, the first stage valid shift register 510 sends downward trigger signal (ST_D1) 504 to second stage valid shift register 512 through an output signal line in time with the first clock signal (CK1). After the downward trigger signal (ST_D1) 504 is sent to the second stage valid shift register 512 to trigger the second stage valid shift register 512, the second stage valid shift register 512 sends downward trigger signal (ST_D2) 506 to third stage valid shift register 514 through an output signal line to trigger third stage valid shift register 514 in time with second clock signal (CK2). Then, the third stage valid shift register 514 sends downward trigger signal (ST_D3) 508 to fourth stage valid shift register 516 through an output signal line in time with the third clock signal (CK3). This process continues until the last stage dummy shift register 518 receives a downward trigger signal.

After upward start pulse signal generator 401 inputs an upward start pulse signal (ST_U) 522 to the last stage valid shift register 530 through an output signal line to trigger the last stage valid shift register 530, the last stage valid shift register 530 sends upward trigger signal (ST_U1) 524 to second-to-last stage valid shift register 532 through output signal line in time with the third clock signal (CK3). After upward start pulse signal (ST_U1) 524 is sent to the second-to-last stage valid shift register 532 to trigger the second-to-last stage valid shift register 532, the second-to-last stage valid shift register 532 sends upward trigger signal (ST_U2) 526 through an output signal line to third-to-last stage valid shift register 534 in time with the second clock signal (CK2). After the upward trigger signal (ST_U2) 526 is sent to the third-to-last stage valid shift register 534 to trigger the third-to-last stage valid shift register 534, the third-to-last stage valid shift register 534 sends upward trigger signal (ST_U3) 528 through an output signal line to the fourth-to-last stage valid shift register 536 in time with the first clock signal (CK1). This process continues until the first stage dummy shift register 520 receives an upward trigger signal.

Please refer to FIG. 5A and FIG. 5B. The downward start pulse signal 502 is inputted in pulse form to the first stage valid shift register 510. Then, the first stage valid shift register 510 outputs the pulse (downward trigger signal 504) to the second stage valid shift register 512. Also, when the downward trigger signal 504 and the first clock signal (CK1) move simultaneously, the first valid data (D1) is read. Then, the second stage valid shift register 512 outputs the pulse (downward trigger signal 506) to the third stage valid shift register 514, and when the downward trigger signal 506 and the second clock signal (CK2) move simultaneously, the second valid data (D2) is read. Then, the third stage valid shift register 514 outputs the pulse (downward trigger signal 508) to the fourth stage valid shift register 516. Also, when the downward trigger signal 508 and the third clock signal (CK3) move simultaneously, the third valid data (D3) is read. In the same manner, the output signal line of each shift register stage sends a pulse (ST_D4, . . . , ST_D1080, Dummy_D1, Dummy_D2) sequentially to trigger the next-stage shift register, and data (D4, D5, D6 . . . ) is read out gradually according to the transmission process described above until the last stage dummy shift register 518 receives the last stage pulse Dummy_D2. The start pulse shift operation described above is a downward shift, and each shift register stage operates in the same direction while completing data transmission.

Please refer to FIG. 5A and FIG. 5C. The upward start pulse signal 522 is outputted in pulse form to the last stage valid shift register 530. Then, the last stage valid shift register 530 outputs the pulse (upward trigger signal 524) to the second-to-last stage valid shift register 532. Also, when the upward trigger signal 524 and the third clock signal (CK3) move simultaneously, the first valid data (D1) is read. Then, second-to-last stage valid shift register 532 outputs the pulse (upward trigger signal 526) to the third-to-last stage valid shift register 534. When the upward trigger signal 526 and the second clock signal (CK2) move simultaneously, the second valid data (D2) is read. Then, the third-to-last stage valid shift register 534 outputs the pulse (upward trigger signal 528) to the fourth-to-last stage valid shift register 536. When the upward trigger signal 528 and the first clock signal (CK1) move simultaneously, the third valid data (D3) is read. In the same manner, the output signal line of each shift register stage sends a pulse (ST_U4, . . . , ST_U1080, Dummy_U1, Dummy_U2) sequentially to trigger the previous-stage shift register, and data (D4, D5, D6 . . . ) is read out gradually according to the transmission process described above until the first stage dummy shift register 520 receives the last stage pulse Dummy_U2. The start pulse shift operation described above is an upward shift, and each shift register stage operates in the same direction while completing data transmission. In this embodiment, each dummy shift register may be a unidirectional shift register instead of a bi-directional shift register, because the dummy shift registers shown in FIG. 5A are only used for transferring the trigger signals in one direction.

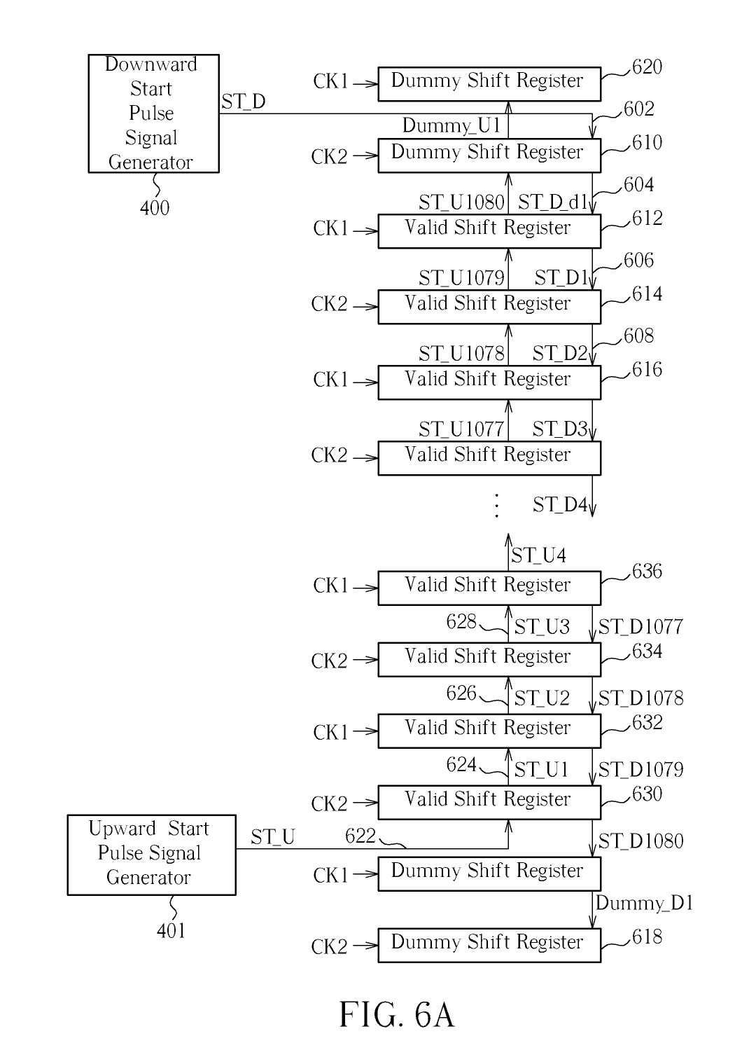

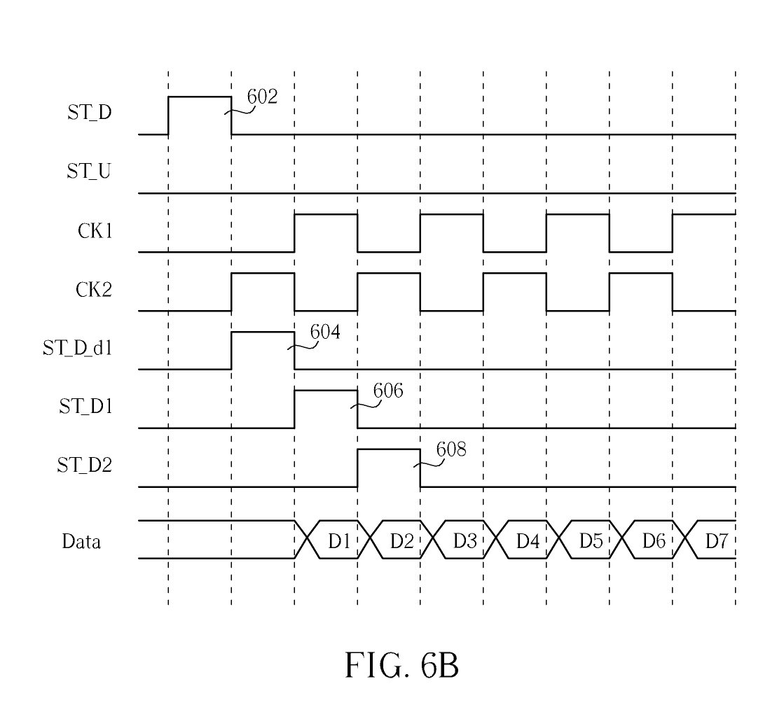

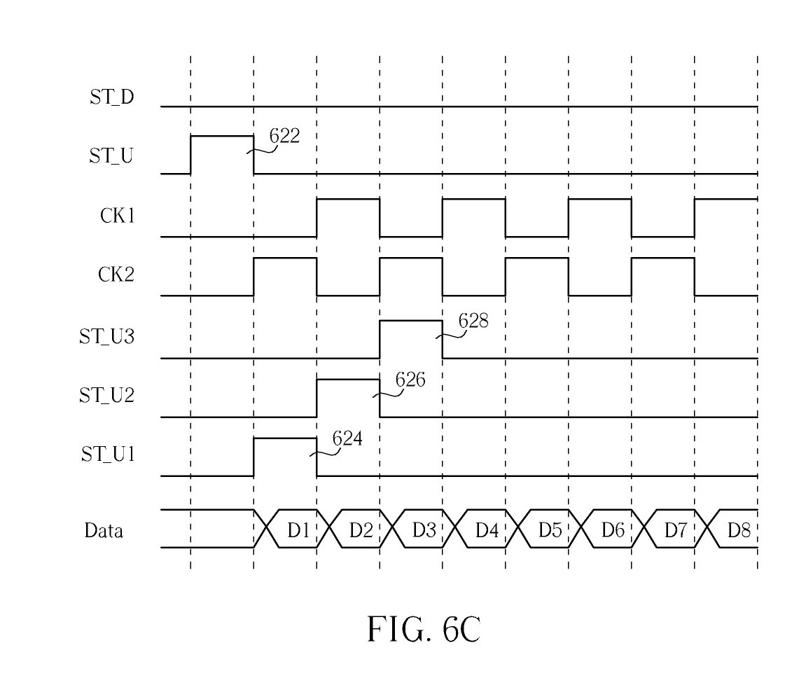

Please refer to FIG. 6A, FIG. 6B, and FIG. 6C. FIG. 6A is a circuit block diagram illustrating a shift register according to a third embodiment. FIG. 6B is a partial timing diagram illustrating a top-to-bottom shift according to the third embodiment. FIG. 6C is a diagram illustrating a bottom-to-top shift according to the third embodiment. In the present embodiment, the two groups of dummy shift registers individually comprise two dummy shift registers.

Please refer to FIG. 6A. After downward start pulse signal generator 400 inputs a downward start pulse signal (ST_D) 602 to second stage dummy shift register 610 through an output signal line to trigger the second stage dummy shift register 610, the second stage dummy shift register 610 sends downward trigger signal (ST_D_d1) 604 through output signal line to the first stage valid shift register 612 in time with the second clock signal (CK2). After the downward trigger signal (ST_D_d1) 604 is sent to the first stage valid shift register 612 to trigger the first stage valid shift register 612, the first stage valid shift register 612 sends downward trigger signal (ST_D1) 606 through an output signal line to second stage valid shift register 614 to trigger the second stage valid shift register 614 in time with the first clock signal (CK1). Then, the second stage valid shift register 614 sends downward trigger signal (ST_D2) 608 through an output signal line to the third stage valid shift register 616 in time with the second clock signal (CK2). This process continues until the last stage dummy shift register 618 receives a downward trigger signal.

After upward start pulse signal generator 401 inputs an upward start pulse signal (ST_U) 622 to the last stage valid shift register 630 through an output signal line to trigger the last stage valid shift register 630, the last stage valid shift register 630 sends upward trigger signal (ST_U1) 624 through an output signal line to second-to-last stage valid shift valid shift register 632 in time with the second clock signal (CK2). After the upward start pulse signal (ST_U1) 624 is sent to the second-to-last stage valid shift register 632 to trigger the second-to-last stage valid shift register 632, the second-to-last stage valid shift register 632 sends upward trigger signal (ST_U2) 626 through an output signal line to the third-to-last stage valid shift register 634 in time with the first clock signal (CK1). After the upward trigger signal (ST_U2) 626 is sent to the third-to-last stage valid shift register 634 to trigger the third-to-last stage valid shift register 634, the third-to-last stage valid shift register 634 sends the upward trigger signal (ST_U3) 628 through an output signal line to the fourth-to-last stage valid shift register 636 in time with the second clock signal (CK2). This process continues until the first stage dummy shift register 620 receives an upward trigger signal.

Please refer to FIG. 6A and FIG. 6B. The downward start pulse signal 602 is inputted in pulse form to the second stage dummy shift register 610. Then, the second stage dummy shift register 610 outputs the pulse (downward trigger signal 604) to the first stage valid shift register 612. Then, the first stage valid shift register 612 outputs the pulse (downward start pulse signal 606) to the second stage valid shift register 614. When the downward trigger signal 606 and the first clock signal (CK1) move simultaneously, the first valid data (D1) is read. Then, the second stage valid shift register 614 outputs the pulse (downward trigger signal 608) to the third stage valid shift register 616. When the downward trigger signal 608 and the second clock signal (CK2) move simultaneously, the second valid data (D2) is read. In the same manner, the output signal line of each shift register stage sends a pulse (ST_D4, . . . , ST_D1080, Dummy_D1) sequentially to trigger the next-stage shift register, and data (D3, D4, D5, D6 . . . ) is read out according to the transmission process described above until the last stage dummy shift register 618 receives the last stage pulse Dummy_D1. The start pulse shift operation described above is an downward shift, and each shift register stage operates in the same direction while completing data transmission.

Please refer to FIG. 6A and FIG. 6C. The upward start pulse signal 622 is inputted in pulse form to the last stage valid shift register 630. Then, the last stage valid shift register 630 outputs the pulse (upward trigger signal 624) to the second-to-last stage valid shift register 632. When the upward trigger signal 624 and the second clock signal (CK2) move simultaneously, the first valid data (D1) is read. Then, the second-to-last stage valid shift register 632 outputs the pulse (upward trigger signal 626) to the third-to-last stage valid shift register 634. When the upward trigger signal 626 and the first clock signal (CK1) move simultaneously, the second valid data (D2) is read. Then, the third-to-last stage valid shift register 634 outputs the pulse (upward trigger signal 628) to the fourth-to-last stage valid shift register 636. When the upward trigger signal 628 and the second clock signal (CK2) move simultaneously, the third valid data (D3) is read. In the same manner, the output signal line of each shift register stage outputs a pulse (ST_U4, . . . , ST_U1080, Dummy_U1) sequentially to trigger the previous stage shift register, and data (D4, D5, D6 . . . ) is read out gradually according to the transmission process described above until the first stage dummy shift register 620 receives the last stage pulse Dummy_U1. The start pulse shift operation described above is an upward shift, and each shift register stage operates in the same direction while completing data transmission. In this embodiment, the dummy shift register 640 must be a bi-directional shift register, but all other dummy shift registers may be unidirectional shift registers instead of bi-directional shift registers, because the other dummy shift registers are only used for transferring the trigger signals in one direction.

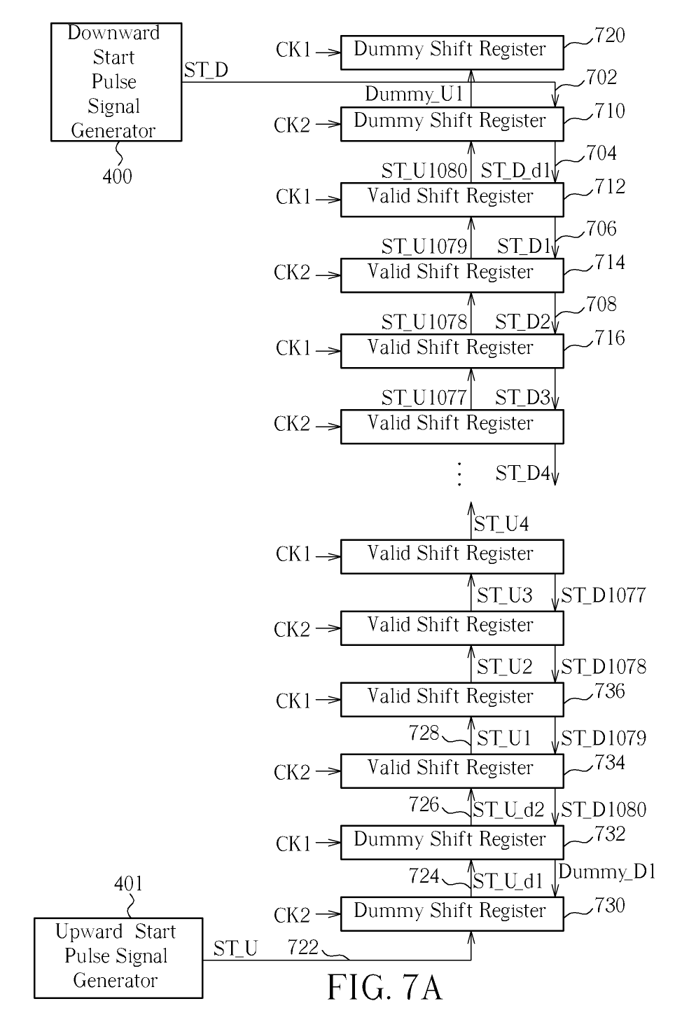

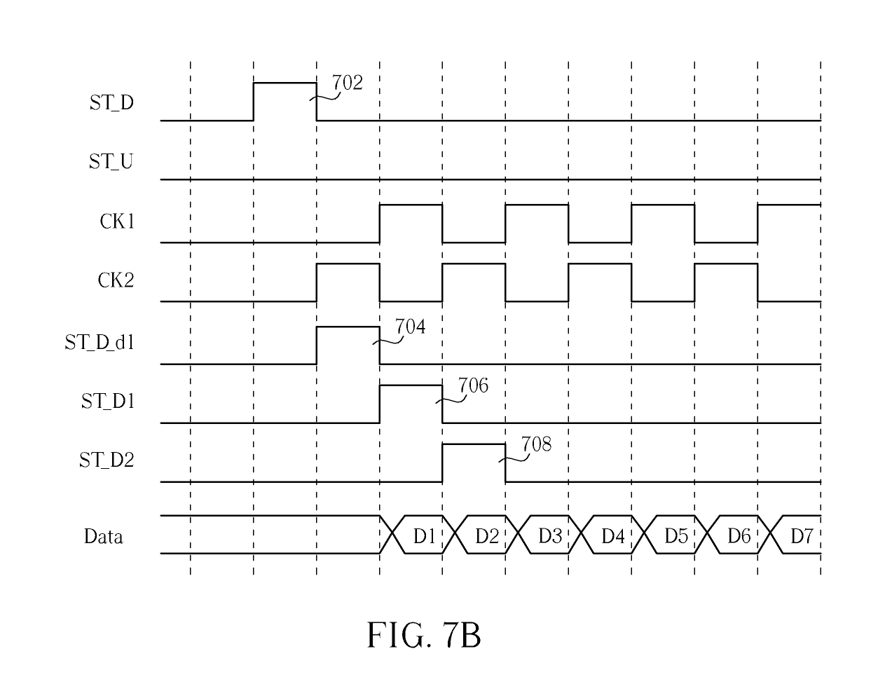

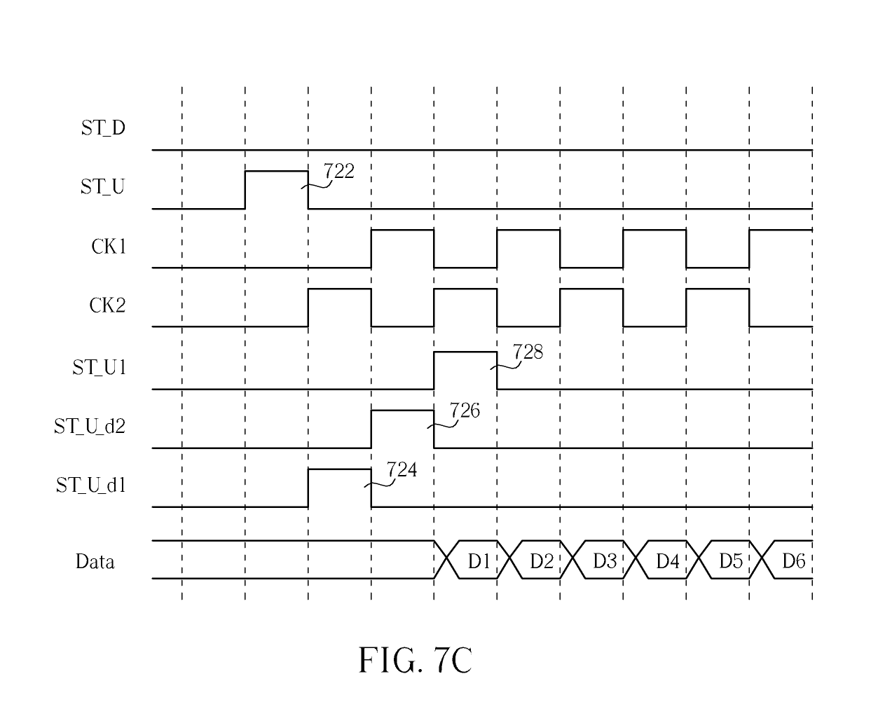

Please refer to FIG. 7A, FIG. 7B, and FIG. 7C. FIG. 7A is a circuit block diagram illustrating a shift register according to a fourth embodiment. FIG. 7B is a partial timing diagram illustrating top-to-bottom shift according to the fourth embodiment, and FIG. 7C is a partial timing diagram illustrating bottom-to-top shift according to the fourth embodiment. In the present embodiment, the two groups of dummy shift registers individually comprise two dummy shift registers. Please refer to FIG. 7A. After the downward start pulse signal generator 400 inputs a downward start pulse signal (ST_D) 702 through an output signal line to second stage dummy shift register 710 to trigger the second stage dummy shift register 710, the second stage dummy shift register 710 sends downward trigger signal (ST_D_d1) through an output signal line to first stage valid shift register 712 in time with the second clock signal (CK2). After the downward trigger signal (ST_D_d1) 704 is sent to the first stage valid shift register 712 to trigger the first stage valid shift register 712, the first stage valid shift register 712 sends downward trigger signal (ST_D1) 706 through an output signal line to second stage valid shift register 714 to trigger the second stage valid shift register 714 in time with the first clock signal (CK1). Then, the second stage valid shift register 714 sends downward trigger signal (ST_D2) 708 through an output signal line to third stage valid shift register 716 in time with the second clock signal (CK2). This process continues until the last stage dummy shift register 730 receives a downward trigger signal.

After the upward start pulse signal generator 401 inputs upward start pulse signal (ST_U) 722 through an output signal line to the last stage dummy shift register 730 to trigger the last stage dummy shift register 730, the dummy shift register 730 sends upward trigger signal (ST_U_d1) 724 through an output signal line to second-to-last stage dummy shift register 732 in time with the second clock signal (CK2). After the upward start pulse signal (ST_U_d1) 724 is sent to the second-to-last stage dummy shift register 732 to trigger the second-to-last stage dummy shift register 732, the second-to-last stage dummy shift register 732 sends upward trigger signal (ST_U_d2) 726 through an output signal line to the last stage valid shift register 734 to trigger the last stage valid shift register 734 in time with the first clock signal (CK1). Then the last stage valid shift register 734 sends upward trigger signal (ST_U1) 728 through an output signal line to second-to-last stage valid shift register 736 in time with the second clock signal (CK2). This process continues until the first stage dummy shift register 720 receives an upward trigger signal.

Please refer to FIG. 7A and FIG. 7B. The downward start pulse signal 702 is inputted in pulse form to the second stage dummy shift register 710. Then, the second stage dummy shift register 710 outputs the pulse (downward trigger signal 704) to the first stage valid shift register 712. Then, the first stage valid shift register 712 outputs the pulse (downward start pulse signal 706) to the second stage valid shift register 714. When the downward trigger signal 706 and the first clock signal (CK1) move simultaneously, the first valid data (D1) is read. Then, the second stage valid shift register 714 outputs the pulse (downward trigger signal 708) to the third stage valid shift register 716. When the downward trigger signal 708 and the second clock signal (CK2) move simultaneously, the second valid data (D2) is read. In the same manner, the output signal line of each shift register stage sends a pulse (ST_D3, . . . , ST_D1080, Dummy_D1) sequentially to trigger the next-stage shift register, and data (D3, D4, D5, D6 . . . ) is read out gradually according to the timing process described above until the last stage dummy shift register 730 receives the last stage pulse Dummy_D1. The start pulse shift operation described above is an downward shift, and each shift register stage operates in the same direction while completing data transmission.

Please refer to FIG. 7A and FIG. 7C. The upward start pulse signal 722 is inputted in pulse form to the last stage dummy shift register 730. Then, the last stage dummy shift register 730 outputs the pulse (upward trigger signal 724) to the second-to-last stage dummy shift register 732. Then, the second-to-last stage dummy shift register 732 outputs the pulse (upward trigger signal 726) to the last stage valid shift register 734. Then, the last stage valid shift register 734 outputs the pulse (upward trigger signal 728) to the second-to-last stage valid shift register 736. When the upward trigger signal 728 and the second clock signal (CK2) move simultaneously, the first valid data (D1) is read. In the same manner, the output signal line of each shift register stage sends a pulse (ST_U2, . . . , ST_U1080, Dummy_U1) sequentially to trigger the previous-stage shift register, and data (D2, D3, D4 . . . ) is read out gradually according to the transmission process described above until the first stage dummy shift register 720 receives the last stage pulse Dummy_U1. The start pulse shift operation described above is an upward shift, and each shift register stage operates in the same direction while completing data transmission. In this embodiment, the dummy shift register 720 may be a unidirectional shift register instead of a bi-directional shift register, but all other dummy shift registers must be bi-directional shift registers, because the other dummy shift registers may be used for performing bi-directional triggering.

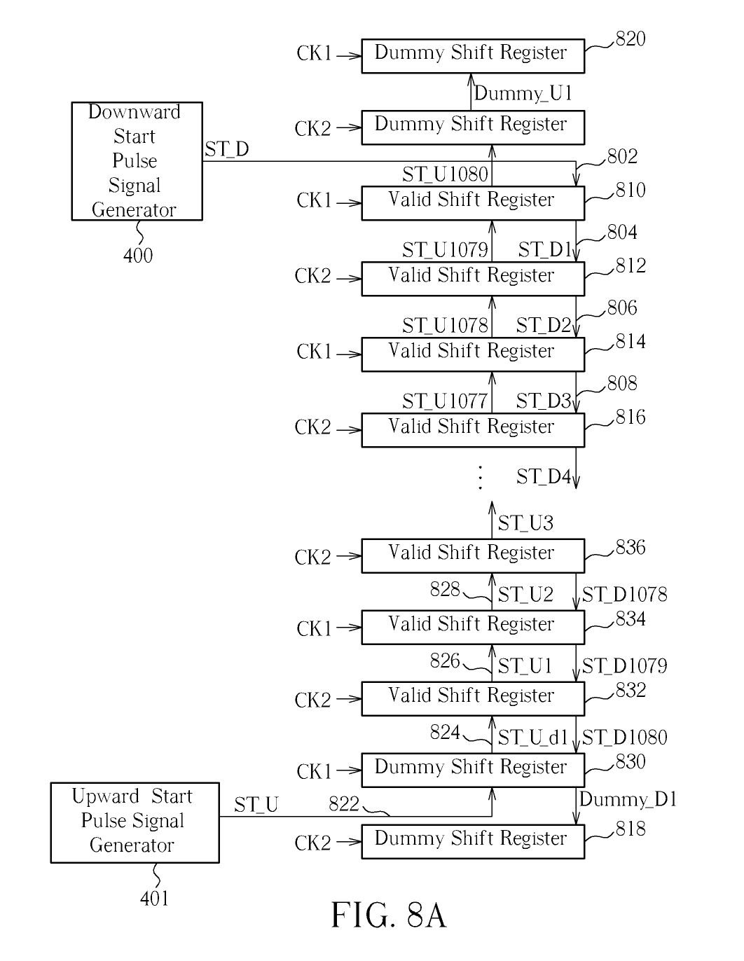

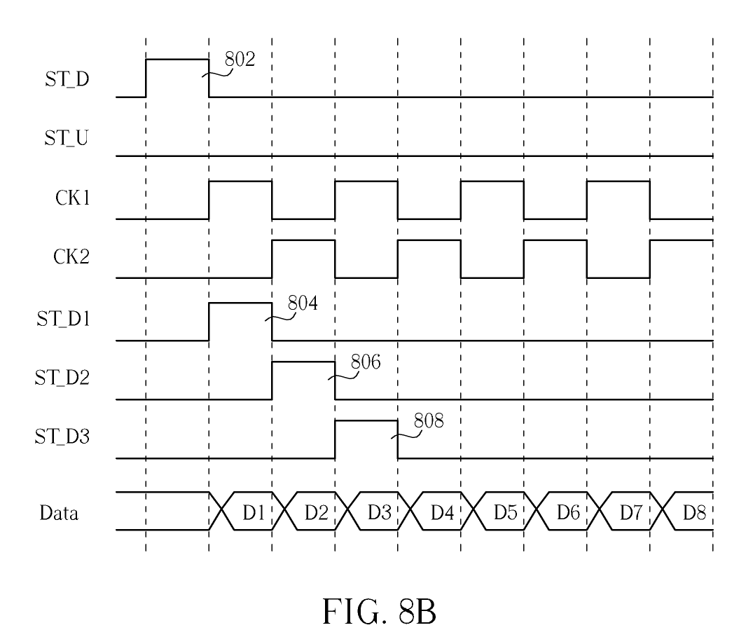

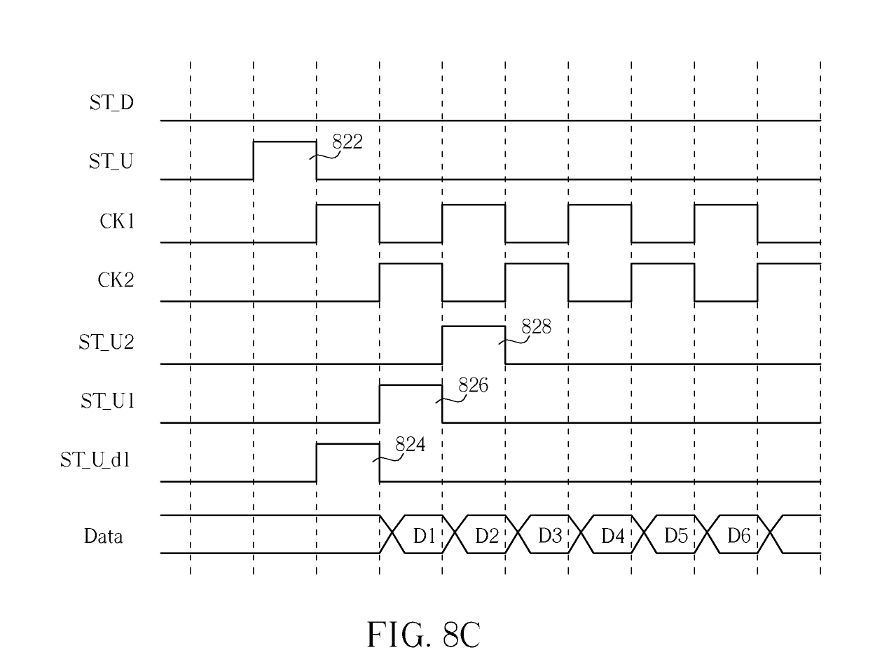

Please refer to FIG. 8A, FIG. 8B, and FIG. 8C. FIG. 8A is a circuit block diagram illustrating a shift register according to a fifth embodiment. FIG. 8B is a partial timing diagram illustrating top-to-bottom shift according to the fifth embodiment, and FIG. 8C is a partial timing diagram illustrating bottom-to-top shift according to the fifth embodiment. In the present embodiment, the two groups of dummy shift registers individually comprise two dummy shift registers. Please refer to FIG. 8A. After the downward start pulse signal generator 400 inputs a downward start pulse signal (ST_D) 802 through an output signal line to a first stage valid shift register 810 to trigger the first stage valid shift register 810, the first stage valid shift register 810 sends downward trigger signal (ST_D1) 804 through an output signal line to second stage valid shift register 812 in time with the first clock signal (CK1). After the downward trigger signal (ST_D1) 804 is sent to the second stage valid shift register 812 to trigger the second stage valid shift register 812, the second stage valid shift register 812 sends downward trigger signal (ST_D2) 806 through an output signal line to third stage valid shift register 814 in time with the second clock signal (CK2). After the downward trigger signal (ST_D2) 806 is sent to the third stage valid shift register 814 to trigger the third stage valid shift register 814, the third stage valid shift register 814 sends downward trigger signal (ST_D3) 808 through an output signal line to fourth stage valid shift register 816 in time with the first clock signal (CK1). This process continues until the last stage dummy shift register 818 receives the downward trigger signal.

After the upward start pulse signal generator 401 inputs an upward start pulse signal (ST_U) 822 through an output signal line to second-to-last stage dummy shift register 830 to trigger the second-to-last stage dummy shift register 830, the second-to-last stage dummy shift register 830 sends upward trigger signal (ST_U_d1) 824 through an output signal line to the last stage valid shift valid shift register 832 in time with the first clock signal (CK1). After the upward trigger signal (ST_U_d1) 824 is sent to the last stage valid shift register 832 to trigger the last stage valid shift register 832, the last stage valid shift register 832 sends upward trigger signal (ST_U1) 826 through an output signal line to second-to-last stage valid shift register 834 in time with the second clock signal (CK2). After the upward trigger signal (ST_U1) 826 is sent to the second-to-last stage valid shift register 834 to trigger the second-to-last stage valid shift register 834, the second-to-last stage valid shift register 834 sends upward trigger signal (ST_U2) 828 through an output signal line to third-to-last stage valid shift register 836 in time with the first clock signal (CK1). This process continues until the first stage dummy shift register 820 receives an upward trigger signal.

Please refer to FIG. 8A and FIG. 8B. The downward start pulse signal (ST_D) 802 is inputted in pulse form to the first stage valid shift register 810. Then, the first stage valid shift register 810 outputs the pulse (downward trigger signal 804) to the second stage valid shift register 812. When the downward trigger signal (ST_D1) 804 and the first clock signal (CK1) move simultaneously, the first valid data (D1) is read. Then, the second stage valid shift register 812 outputs the pulse (downward trigger signal 806) to the third stage valid shift register 814. When the downward trigger signal (ST_D2) 806 and the second clock signal (CK2) move simultaneously, the second valid data (D2) is read. Then, third stage valid shift register 814 outputs the pulse (downward trigger signal 808) to the fourth stage valid shift register 816. When the downward trigger signal (ST_D3) 808 and the first clock signal (CK1) move simultaneously, the third valid data (D3) is read. In the same manner, the output signal line of each shift register stage sends a pulse (ST_D4, . . . , ST_D1080, Dummy_D1) sequentially to trigger the next-stage shift register, and data (D4, D5, D6 . . . ) is read out gradually according to the timing process described above until the last stage dummy shift register 818 receives the last stage pulse Dummy_D1. The start pulse shift operation described above is an downward shift, and each shift register stage operates in the same direction while completing data transmission.

Please refer to FIG. 8A and FIG. 8C. The upward start pulse signal (ST_U) 822 is inputted in pulse form to the second-to-last stage dummy shift register 830. Then, the second-to-last stage dummy shift register 830 outputs the pulse (upward trigger signal 824) to the last stage valid shift register 832. Then, the last stage valid shift register 832 outputs the pulse (upward trigger signal 826) to the second-to-last stage valid shift register 834. When the upward trigger signal (ST_U1) 826 and the second clock signal (CK2) move simultaneously, the first valid data (D1) is read. Then, the second-to-last stage valid shift register 834 outputs the pulse (upward trigger signal 828) to the third-to-last stage valid shift register 836. When the upward trigger signal (ST_U2) 828 and the first clock signal (CK1) move simultaneously, the second valid data (D2) is read. In the same manner, the output signal line of each shift register sends a pulse (ST_U3, . . . , ST_U1080, Dummy_U1) sequentially to trigger the previous-stage shift register, and data (D3, D4, D5, D6 . . . ) is read out gradually according to the timing process described above until first stage dummy shift register 820 receives the last stage pulse Dummy_U1. The start pulse shift operation described above is an upward shift, and each shift register stage operates in the same direction while completing data transmission. In this embodiment, each dummy shift register may be a unidirectional shift register instead of a bi-directional shift register, because the dummy shift registers are only used for performing unidirectional triggering.

The embodiments described above input at least one start pulse signal of an upward start pulse signal and a downward start pulse signal directly to a non-first-stage dummy shift register to avoid the trigger signal transmission delay caused by the traditional architecture, which consumes extra time in transferring the trigger signal. Not only do the embodiments support real-time data output, but they also reduce the extra storage requirements placed on memory. The embodiments can also be used flexibly in any shift register design by altering input location.

Those skilled in the art will readily observe that numerous modifications and alterations of the device and method may be made while retaining the teachings of the invention.

What is claimed is:

1. A display comprising:
a display panel having N gate lines;
a first group of dummy shift registers comprising at least one dummy shift register;
a second group of dummy shift registers comprising at least one dummy shift register;
a plurality of valid shift registers coupled between the second group of dummy shift registers, a first valid shift register coupled to the first group of dummy shift registers, an Nth valid shift register coupled to the second group of dummy shift registers; and
a first-directional start pulse signal generator coupled to the first valid shift register for inputting a first-directional start pulse signal to the first valid shift register for enabling a first gate line.

2. The display of claim 1, further comprising a second-directional start pulse signal generator coupled to the Nth valid shift register for inputting a second-directional start pulse signal to the Nth valid shift register for enabling an Nth gate line.

3. The display of claim 2, wherein the second-directional start pulse signal generator is an upward start pulse signal generator.

4. The display of claim 1, further comprising a second-directional start pulse signal generator coupled to a dummy shift register of the second group of dummy shift registers for inputting a second-directional start pulse signal to the dummy shift register.

5. The display of claim 4, wherein the second-directional start pulse signal generator is an upward start pulse signal generator.

6. The display of claim 1, wherein the first-directional start pulse signal generator is a downward start pulse signal generator.

7. The display of claim 1, wherein each group of dummy shift registers comprises at least one unidirectional shift register.

8. The display of claim 1, wherein each group of dummy shift registers comprises at least one bi-directional shift register.

9. The display of claim 1, wherein the plurality of valid shift registers is a plurality of bi-directional shift registers.

10. A display comprising:
a display panel having N gate lines;
a first group of dummy shift registers having m dummy shift registers, wherein an ith dummy shift register is coupled to an (i+1)th dummy shift register, and m−1≧i≧1;
a second group of dummy shift registers;
a plurality of valid shift registers coupled between the second group of dummy shift registers, a first valid shift register coupled to an mth dummy shift register of the first group of dummy shift registers, an Nth valid shift register coupled to the second group of dummy shift registers; and
a first-directional start pulse signal generator coupled to a jth dummy shift register of the first group of dummy shift registers for inputting a first-directional start pulse signal to the jth dummy shift register;
wherein j does not equal 1.

11. The display of claim 10, further comprising a second-directional start pulse signal generator coupled to the Nth valid shift register for inputting a second-directional start pulse signal to the Nth valid shift register for enabling an Nth gate line.

12. The display of claim 11, wherein the second-directional start pulse signal generator is an upward start pulse signal generator.

13. The display of claim 10, further comprising a second-directional start pulse signal generator coupled to a dummy shift register of the second group of dummy shift registers for inputting a second-directional start pulse signal to the dummy shift register.

14. The display of claim 13, wherein the second-directional start pulse signal generator is an upward start pulse signal generator.

15. The display of claim 10, wherein the first-directional start pulse signal generator is a downward start pulse signal generator.

16. The display of claim 10, wherein each group of dummy shift registers comprises at least one unidirectional shift register.

17. The display of claim 10, wherein each group of dummy shift registers comprises at least one bi-directional shift register.

18. The display of claim 10, wherein the plurality of valid shift registers is a plurality of bi-directional shift registers.
